(19) United States
(12) Patent Application Publication
(10) Pub. No.: US 2025/0201469 A1
(43) Pub. Date: Jun. 19, 2025

(54) COIL COMPONENT

(71) Applicant: SAMSUNG ELECTRO-MECHANICS CO., LTD., Suwon-si (KR)

(72) Inventors: Jae Hun KIM, Suwon-si (KR); Tae Hyun KIM, Suwon-si (KR); Dong Jin LEE, Suwon-si (KR); Su Min SEO, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/909,100

(22) Filed: Oct. 8, 2024

(30) Foreign Application Priority Data
Dec. 19, 2023 (KR) 10-2023-0185395

(51) Int. Cl. H01F 27/29; H01F 27/255; H01F 27/32

(52) U.S. Cl. CPC H01F 27/29; H01F 27/255; H01F 27/32

(57) ABSTRACT

A coil component includes: a body; a coil disposed within the body; a support member disposed within the body to support the coil; a pair of first connection portions extending from the support member to one side surface of the body; and a pair of second connection portions extending from the support member to another side surface, facing the one side surface of the body. When a length of the body in a first direction is L, and a distance between the pair of first connection portions extending to the one side surface of the body in a second direction, spaced apart in the first direction is S, S/L satisfies 0.15 or more and 0.65 or less.

### CROSS-REFERENCE TO RELATED APPLICATION(S)

This application claims benefit of priority to Korean Patent Application No. 10-2023-0185395 filed on Dec. 19, 2023, in the Korean Intellectual Property Office, the disclosure of which is incorporated herein by reference in its entirety.

### TECHNICAL FIELD

The present disclosure relates to a coil component.

### BACKGROUND

An inductor, a type of coil component, is a representative manual electronic component used in electronic devices, along with a resistor and a capacitor.

As electronic devices become improved in terms of performance and smaller, the number of electronic components used in electronic devices is increasing and the electronic components are becoming smaller.

Accordingly, thin-film inductors used in such electronic devices are also required to be miniaturized and thinned. Although the thickness of power inductors is becoming thinner, research and development is being conducted to increase the number of turns of a coil pattern (fine patterning), develop materials with high magnetic permeability, and increase a height of the pattern, to achieve miniaturization of products without loss of chip characteristics such as inductance, RDC, and the like.

### SUMMARY

An aspect of the present disclosure is to provide a coil component that may be thinned (low-profile) and prevent deformation of a coil and a support member.

Another aspect of the present disclosure is to provide a coil component that can prevent deterioration in inductance characteristics by maximizing a volume of a magnetic material within the component.

According to an aspect of the present disclosure, provided is a coil component, the coil component including: a body; a coil disposed within the body; a support member disposed within the body to support the coil; a pair of first connection portions extending from the support member to one side surface of the body; and a pair of second connection portions extending from the support member to another side surface, facing the one side surface of the body. When a length of the body in a first direction is L, and a distance between the pair of first connection portions extending to the one side surface of the body in a second direction, spaced apart in the first direction is S, S/L satisfies 0.15 or more and 0.65 or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to an embodiment of the present disclosure;

FIG. 2 is a plan view schematically illustrating a coil component according to an embodiment of the present disclosure;

FIG. 3 is the same plan view as that of FIG. 2, but with different reference numerals;

FIG. 4 is a diagram illustrating a cross-section along line I-I′ of FIG. 1;

FIG. 5 is a diagram illustrating a cross-section taken along line II-II′ of FIG. 1;

FIG. 6 is a plan view schematically illustrating a coil component according to a modified example of the present disclosure; and

FIG. 7 is a diagram illustrating a conventional coil component (comparative example).

### DETAILED DESCRIPTION

The term used herein is for the purpose of describing particular embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof. Furthermore, throughout the specification, the term “on” means positioning above or below the object portion, but does not essentially mean positioning on the upper side of the object portion based on a gravity-direction.

In addition, the term “coupled to,” “combined to,” and the like, may not only indicate that elements are directly and physically in contact with each other, but also include the configuration in which the other element is interposed between the elements such that the elements are also in contact with the other component.

In the drawings, sizes and thicknesses of elements illustrated in the drawings are indicated as examples for ease of description, and embodiments in the present disclosure are not limited thereto.

In the drawings, an X-direction may be defined as a first direction or a longitudinal direction, a Y-direction may be a second direction or a width direction, and a Z-direction may be a third direction or a thickness direction.

In the descriptions described with reference to the accompanied drawings, the same elements or elements corresponding to each other will be described using the same reference numerals, and overlapping descriptions will not be repeated.

In electronic devices, various types of electronic components may be used, and various types of coil components may be used between the electronic components to remove noise, or for other purposes.

In other words, in electronic devices, a coil component may be used as a power inductor, a high frequency (HF) inductor, a general bead, a GHz bead, a common mode filter, a common mode filter, or the like.

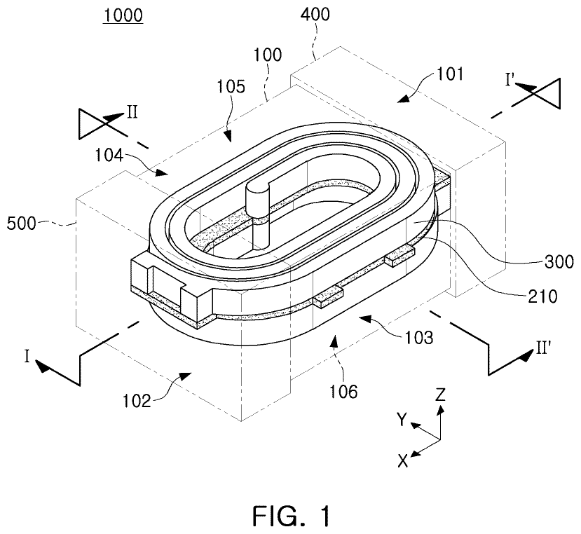

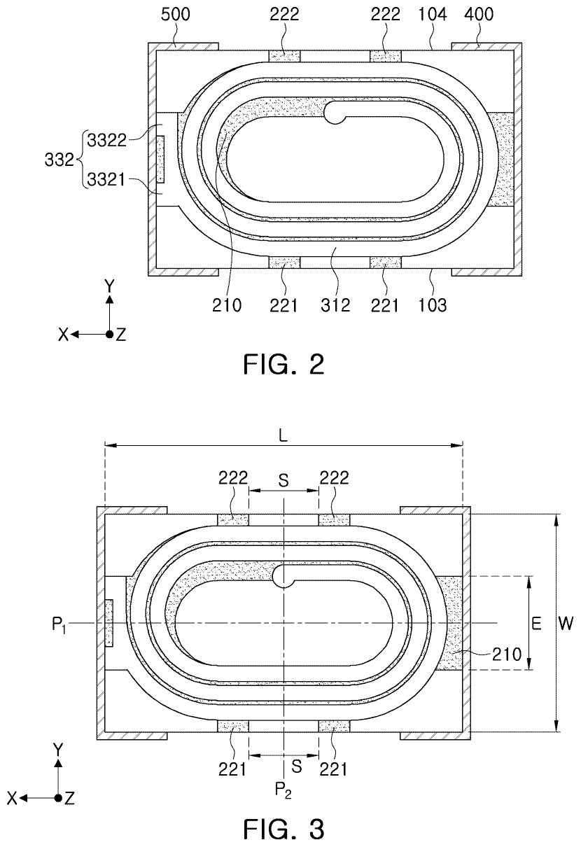

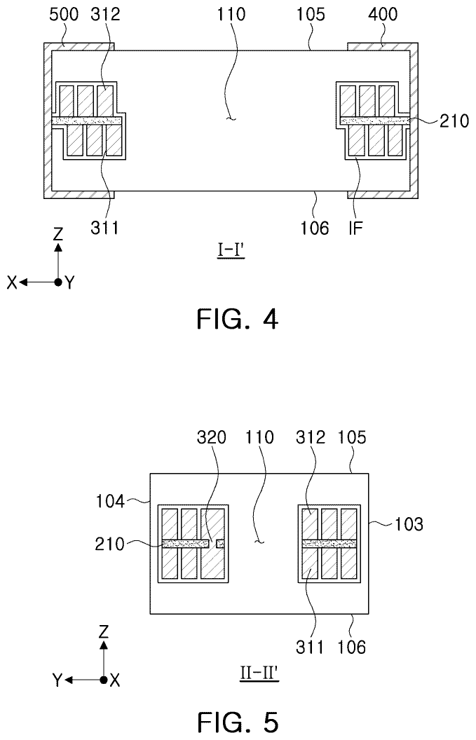

FIG. 1 is a perspective view schematically illustrating a coil component according to an embodiment of the present disclosure. FIG. 2 is a plan view schematically illustrating a coil component according to an embodiment of the present disclosure. FIG. 3 is the same plan view as that of FIG. 2, but with different reference numerals. FIG. 4 is a diagram illustrating a cross-section along line I-I′ of FIG. 1. FIG. 5 is a diagram illustrating a cross-section taken along line II-II′ of FIG. 1.

Referring to FIGS. 1 to 5, a coil component 1000 according to an embodiment of the present disclosure may include a body 100, a support member 210, connection portions 221 and 222, a coil 300, and external electrodes 400 and 500, and may further include an insulating film IF.

The body 100 may form an exterior of the coil component 1000 according to the present embodiment, and the support member 210 and the coil 300 are buried therein.

The body 100 may be formed in a hexahedral shape as a whole.

Based on FIGS. 1 to 5, the body 100 includes a first surface 101 and a second surface 102 opposing each other in the first direction (X-direction), a third surface 103 and a fourth surface 104 opposing each other in the second direction (Y-direction), and a fifth surface 105 and a sixth surface 106 opposing each other in the third direction (Z-direction). Each of the first to fourth surfaces 101, 102, 103 and 104 of the body 100 corresponds to side surfaces of the body 100 connecting the fifth surface 105 to the sixth surface 106 of the body 100.

The body 100 may, for example, be formed so that the coil component 1000 according to the present embodiment of the present disclosure in which external electrodes 400 and 500 to be described below are formed has a length of 2.0 mm, a width of 1.2 mm, and a thickness of 0.65 mm, but the present disclosure is not limited to thereto. As another example, the body 100 may be formed so that the coil component 1000 according to the present embodiment of the present disclosure has a length of 2.0 mm, a width of 1.6 mm, and a thickness of 0.55 mm, a length of 2.0 mm, a width of 1.2 mm, and a thickness of 0.55 mm, or a length of 1.2 mm, a width of 1.0 mm, and a thickness of 0.55 mm. The scope of the present disclosure is not limited to the thickness of the exemplary coil component described above.

Based on an optical microscope image or Scanning Electron Microscope (SEM) image of a cross-section in a first direction (X-direction)-a third direction (Z-direction) taken from a central portion of the coil component 1000 in a second direction (Y-direction), the length of the coil component 1000 in the first direction (X-direction) described above may refer to a maximum value among dimensions of a plurality of respective line segments obtained by respectively connecting two outermost boundary lines coil component 1000, facing each other in the first direction (X-direction) of the coil component 1000 illustrated in the cross-sectional image and parallel to the first direction (X-direction). Alternatively, the length of the coil component 1000 may refer to a minimum value among dimensions of a plurality of respective line segments obtained by respectively connecting two outermost boundary lines of the coil component 1000, facing each other in the first direction (X-direction) of the coil component 1000 illustrated in the cross-sectional image and parallel to the first direction (X-direction). Alternatively, the length of the coil component 1000 may refer to an arithmetic mean value of at least five dimensions of a plurality of respective line segments obtained by respectively connecting two outermost boundary lines of the coil component 1000, facing each other in the first direction (X-direction) illustrated in the cross-sectional image and parallel to the first direction (X-direction). In particular, the at least five dimensions may include the maximum and minimum values. Here, the plurality of line segments parallel to the first direction (X-direction) may be equally spaced from each other in the third direction (Z-direction), but the scope of the present disclosure is not limited thereto.

Based on an optical microscope image or Scanning Electron Microscope (SEM) image of a cross-section in a first direction (X-direction)-a second direction (Y-direction) taken from a central portion of the coil component 1000 in a third direction (Z-direction), the length of the coil component 1000 in the second direction (Y-direction) described above may refer to a maximum value among dimensions of a plurality of respective line segments obtained by respectively connecting two outermost boundary lines of the coil component 1000, facing each other in the second direction (Y-direction) of the coil component 1000 illustrated in the cross-sectional image and parallel to the second direction (Y-direction). Alternatively, the length of the coil component 1000 may refer to a minimum value among dimensions of a plurality of respective line segments obtained by respectively connecting two outermost boundary lines of the coil component 1000, facing each other in the second direction (Y-direction) of the coil component 1000 illustrated in the cross-sectional image and parallel to the second direction (Y-direction). Alternatively, the length of the coil component 1000 may refer to an arithmetic mean value of at least five dimensions among dimensions of a plurality of respective line segments obtained by respectively connecting two outermost boundary lines of the coil component 1000, facing each other in the second direction (Y-direction) illustrated in the cross-sectional image and parallel to the second direction (Y-direction). In particular, the at least five dimensions may include the maximum and minimum values. Here, the plurality of line segments parallel to the second direction (Y-direction) may be equally spaced from each other in the first direction (X-direction), but the scope of the present disclosure is not limited thereto.

Based on an optical microscope image or Scanning Electron Microscope (SEM) image of a cross-section in a first direction (X-direction)-a third direction (Z-direction) taken from a central portion of the coil component 1000 in a second direction (Y-direction), the length of the coil component 1000 in the third direction (Z-direction) described above may refer to a maximum value among dimensions of a plurality of respective line segments obtained by respectively connecting two outermost boundary lines of the coil component 1000, facing each other in the third direction (Z-direction) of the coil component 1000 illustrated in the cross-sectional image and parallel to the third direction (Z-direction). Alternatively, the length of the coil component 1000 may refer to a minimum value among dimensions of a plurality of respective line segments obtained by respectively connecting two outermost boundary lines of the coil component 1000, facing each other in the third direction (Z-direction) of the coil component 1000 illustrated in the cross-sectional image and parallel to the third direction (Z-direction). Alternatively, the length of the coil component 1000 may refer to an arithmetic mean value of at least five dimensions among dimensions of a plurality of respective line segments obtained by respectively connecting two outermost boundary lines of the coil component 1000, facing each other in the third direction (Z-direction) illustrated in the cross-sectional image and parallel to the third direction (Z-direction). In particular, the at least five dimensions may include the maximum and minimum values. Here, the plurality of line segments parallel to the third direction (Z-direction) may be equally spaced from each other in the first direction (X-direction), but the scope of the present disclosure is not limited thereto.

Meanwhile, each of the lengths of the coil component 1000 in the first to third directions may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

The body 100 may include a magnetic material and a resin. Specifically, the body 100 may be formed by stacking at least one magnetic composite sheet in which a magnetic material is dispersed in the resin. However, the body 100 may have a structure other than a structure in which the magnetic material is dispersed in the resin. For example, the body 100 may be formed of a magnetic material such as a ferrite.

The magnetic material may be magnetic powder particles, and for example, may be ferrite or magnetic metal powder particles.

Examples of the ferrite powder particles may include, for example, at least one of a spinel-type ferrite such as a Mg—Zn-based ferrite, a Mn—Zn-based ferrite, a Mn—Mg-based ferrite, a Cu—Zn-based ferrite, a Mg—Mn—Sr-based ferrite and a Ni—Zn-based ferrite, a hexagonal ferrite such as a Ba—Zn-based ferrite, a Ba—Mg-based ferrite, a Ba—Ni-based ferrite, a Ba—Co-based ferrite and a Ba—Ni—Co-based ferrite, a garnet-type ferrite such as a Y-based ferrite and the like, and a Li-based ferrite.

The magnetic metal powder particles may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder, Fe—Cr-based alloy powder particles, Fe—Cr—Si-based alloy powder particles, Fe—Si—Cu—Nb-based alloy powder particles, Fe—Ni—Cr-based alloy powder particles, Fe—Cr—Al-based alloy powder particles.

The magnetic metal powder may be amorphous or crystalline. For example, the magnetic metal powder particles may be a Fe—Si—B—Cr-based amorphous alloy powder particles, but the present disclosure is not limited thereto.

Each of the ferrite and the magnetic metal powder particles may have an average diameter of about 0.1 μm to 30 μm, but the present disclosure is not limited thereto.

The body 100 may include two or more types of magnetic materials dispersed in the resin. Here, the fact that magnetic materials are of different types denotes that magnetic materials dispersed in the resin are distinguished from each other by at least one of average diameter, a composition, crystallinity, or a shape. For example, the body 100 may include two or more magnetic powders having different average diameters.

The resin may include epoxy, polyimide, a liquid crystal polymer, alone or in combination thereof, but the present disclosure is not limited thereto.

The body 100 includes a core 110 that penetrates a coil 300, to be described later. The core 110 may be formed by filling a through hole of the coil 300 with a magnetic composite sheet, but the present disclosure is not limited thereto.

A length L of the body 100 in the first direction may be greater than a length W of the body 100 in the second direction.

The support member 210 is buried in the body 100. The support member 210 is configured to support a coil 300, to be described later. A thickness of the support member 210 may be 40 μm or less. Specifically, the thickness of the support member 210 may be 15 μm or more and 40 μm or less, but the present disclosure is not necessarily limited thereto.

The support member 210 may be formed of an insulating material including a thermosetting insulating resin such as an epoxy resin, a thermoplastic insulating resin such as polyimide, or a photosensitive insulating resin, and the support member 210 may be formed of an insulating material in which a reinforcing material such as a glass fiber or an inorganic filler is impregnated in the insulating resin. For example, the support member 210 may be formed of an insulating material such as prepreg, an Ajinomoto Build-up Film (ABF), FR-4, a Bismaleimide Triazine (BT) resin, and photo imageable dielectric (PID), but the present disclosure is not limited thereto.

The inorganic filler may include at least one selected from the group consisting of silica (SiO₂), alumina (Al₂O₃), silicon carbide (SiC), barium sulfate (BaSO₄), talc, mud, mica powder particles, aluminum hydroxide (Al(OH)₃), and magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 210 is formed of an insulating material including a reinforcing material, the support member 210 may provide more excellent rigidity. When the support member 210 is formed of an insulating material that does not include glass fibers, the support member 210 may be advantageous in thinning an overall thickness of the coil 300. When the support member 210 is formed of an insulating material including a photosensitive insulating resin, the number of processes for forming the coil 300 is reduced, which may be advantageous in reducing production costs, and fine vias may be formed.

The support member 210 is a member supporting the first and second coil patterns 311 and 312 and the first and second lead-out portions 331 and 332 of the coil 300, and is formed in a shape corresponding to the shape of the first and second coil patterns 311 and 312 and the first and second lead-out portions 331 and 332. That is, an outer line of the support member 210 may be formed to correspond to an outer line of the coil 300. The support member 210 may be spaced apart from both side surfaces 103 and 104 of the body 100 facing each other in the second direction (Y-direction). This is contrary to the fact that the connection portions 221 and 222 extend to the third and fourth surfaces 103 and 104 of the body. That is, as compared to the conventional coil component (Comparative Example) to be described later, even if the support member 210 is not extended to the third and fourth surfaces 103 and 104, the rigidity of the coil component may be sufficiently secured through the connection portions 221 and 222.

The support member 210 may extend along the first and second lead-out portions 331 and 332 to both side surfaces 101 and 102 of the body 100 facing each other in the first direction (X-direction). When a length of a side surface of the support member 210 extending to both side surfaces 101 and 102 of the body in the second direction (Y-direction) is referred to as E, and a length thereof in the second direction of the body 100 is referred to as W, E/W may be ½ or less.

The length (W) of the body 100 in the second direction (Y direction) of the body 100 may be measured by analogizing the method of measuring the length of the coil component 1000 described above. Likewise, the length (E) of the side surface of the support member 210 extending to both side surfaces 101 and 102 of the body in the second direction (Y-direction) may also be measured by analogizing the above-described method.

The body 100 of the coil component may be formed by stacking and compressing magnetic composite sheets on both surfaces of the support member 210 on which the coil is formed. In this case, pressure and temperature applied to the support member and the coil may increase, so that the possibility of deformation of the support member 210 and the coil 300 may increase (hereinafter referred to as ‘substrate sagging’). In particular, the substrate sagging phenomenon may occur frequently when the thickness of the support member 210 is reduced to 40 μm or less as described above.

In the case of this embodiment, as to be described later, each of the first and second connection parts 221 and 222 may be formed as a pair of connection portions, spaced apart from each other by a length S in the first direction (X-direction) of the body, so that when forming the body 100, the stress applied to the coil 300 and the support member 210 may be reduced.

Hereinafter, the shapes of the connection portions 221 and 222 will be described in detail with reference to FIGS. 2 and 3.

The coil component 1000 according to the present embodiment includes a pair of first connection portions 221 extending from the support member 210 to one side surface of the body 100 and a pair of second connection portions 222 extending from the support member 210 to the other side surface of the body 100.

Specifically, the pair of first connection portions 221 and the pair of second connection portions 222 may respectively extend to both side surfaces 103 and 104 of the body 100 facing in the second direction. Referring to FIG. 2, the pair of first connection portions 221 extend to the third surface 103 of the body 100, and the pair of second connection portions 222 extend to the fourth surface 104.

The first and second connection portions 221 and 222 may prevent deformation of each unit coil by connecting adjacent unit coils to each other when stacking magnetic composite sheets. The first and second connection portions 221 and 222 may be formed to connect each unit support member 210 supporting adjacent unit coils to each other, and then may be separated through a process of individualizing the unit coils, so that each unit coil component 1000 is exposed to the third and fourth surfaces 103 and 104 of the body 100, respectively.

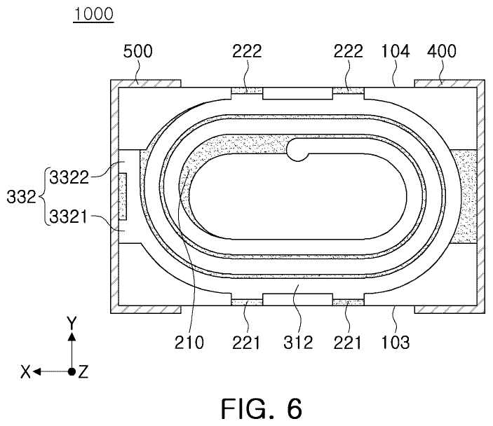

Unlike the support member 210 directly supporting the coil 300, the coil 300 may not be disposed on the first and second connection portions 221 and 222. However, the present disclosure is not necessarily limited thereto. FIG. 6 is a plan view schematically illustrating a coil component according to a modified example of the present disclosure. As an example, when forming the coil 300 through a plating process, a plating region may invade the connecting portions 221 and 222. In this case, the first and second connection portions 221 and 222 are not configured to directly support the coil 300, but at least a portion of the coil 300 may contact at least a portion of the first connection portion 221 and the second connection portion 222.

In the present embodiment, a pair of first connection portions 221 are spaced apart from each other by a length S of the body in the first direction (X-direction). That is, as shown in FIGS. 1 to 3, the pair of first connection portions 221 extend from the support member 210, and a cross-section of each of the pair of first connection portions 221 is exposed to the third surface 103 of the body 100.

Likewise, the pair of second connection portions 222 may be spaced apart from each other by a length S in the first direction (X-direction) of the body. The pair of second connection portions 222 extend from the support member 210, and a cross-section of each of the pair of second connection portions 222 is exposed to the fourth surface 104 of the body 100.

The separation distance(S) between the pair of first connection portions 221 may be substantially same as the separation distance(S) between the pair of second connection portions 222.

As used herein, the expression “substantially same” may refer to being the same distance relative to the distance compared therewith, as will be appreciated by those of skill in the art, and allows for approximations, inaccuracies and limits of measurement under the relevant circumstances. In one or more aspects, the terms “substantially,” “about,” and “approximately” may provide an industry-accepted tolerance for their corresponding terms and/or relativity between items, such as a tolerance of ±1%, ±5%, or ±10% of the actual value stated, and other suitable tolerances.

Because of this, a portion of a magnetic composite sheet for forming the body 100 may flow into the space between the pair of first and second connection portions 221 and 222, thereby minimizing deformation of the support member 210. Furthermore, deformation of the coil 300 disposed on the support member 210 can be minimized.

Referring to FIG. 3, the disposition of the connection portions 221 and 222 will be described in detail. The first and second connection portions 221 and 222 may be formed to be symmetrical to each other. Here, being symmetrically formed is a concept including point symmetry and line symmetry.

When a surface passing through a center of the body 100 in the second direction is referred to as P₁, the pair of first connection portions 221 and the pair of second connection portions 222 may be formed symmetrically to each other, centered on the P₁ surface.

When a surface passing through a center of the body 100 in the first direction is referred to as P₂, the pair of first connection portions 221 may be formed symmetrically to each other, centered on the P₂ surface, and the pair of second connection portions 222 may be formed symmetrically to each other, centered on the P₂ surface.

The first connection portion 221, disposed on a left side, and the second connection portion 222, disposed on the left side, based on a direction of FIG. 3, may be located together on a line segment parallel to the second direction (Y direction) of the body 100. Likewise, the first connection portion 221, disposed on a right side, and the second connection portion 222, disposed on the right side, based on the direction of FIG. 3, may be located together on another line segment parallel to the second direction (Y-direction) of the body 100. In the former and latter cases, the stress applied to the support member 210 and the coil 300 when forming the body 100 may be distributed relatively evenly in the second direction (Y-direction) of the body 100, so that deformation of the coil 300 may be minimized.

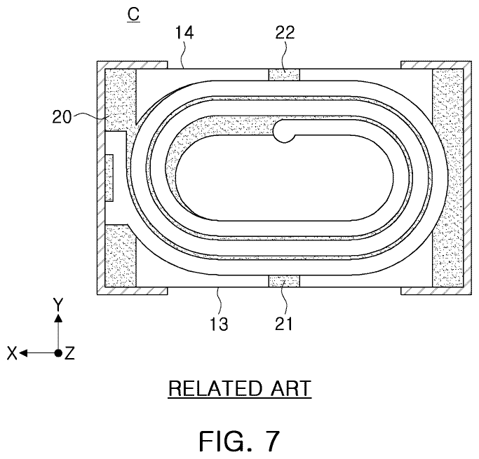

When the length between the pair of first connection portions 221, spaced apart in the first direction (X-direction) is S, and the length of the body 100 in the first direction (X-direction) is L, S/L satisfies 0.15 or more and 0.65 or less.

[Table 1] below is a table illustrating substrate sagging, a Ls change rate, and a chipping defect rate, when the length L of the body 100 in the first direction (X-direction) is kept constant at 2.0 mm, and the length S between the pair of connection portions, spaced apart is adjusted. No. 1 illustrates a conventional coil component (Comparative Example). FIG. 7 is a diagram illustrating a conventional coil component (Comparative Example). In the case of a conventional coil component, the support member 20 around the lead-out portion extended to side surfaces 13 and 14 of the body. That is, in order to secure rigidity of the coil component, an area of the support member 20 was increased.

On the other hand, in Experimental examples (No. 2 to No. 10), the support member 210 was not extended to the side surfaces 103 and 104 of the body, a pair of connection portions 221 and 222 were formed, respectively, and a separation distance(S) between the connection portions 221 and 222 was adjusted.

Chipping defect refers to a phenomenon in which a magnetic material falls off when forming the body 100 through stacking and compression of the magnetic material.

TABLE 1

| | | | | | Ls | Chipping |
|---|---|---|---|---|---|---|
| | | | | Substrate | change | defect |
| No | S[mm] | L[mm] | S/L | sagging | rate[%] | rate[%] |
| 1 | — | — | — | Defective | REF | 1.50 |
| 2 | 0.1 | 2 | 0.05 | Defective | 0.50 | 0.70 |
| 3 | 0.3 | 2 | 0.15 | Good | 1.70 | 0 |
| 4 | 0.5 | 2 | 0.25 | Good | 2.70 | 0 |
| 5 | 0.7 | 2 | 0.35 | Good | 2.10 | 0 |
| 6 | 0.9 | 2 | 0.45 | Good | 1.60 | 0 |
| 7 | 1.1 | 2 | 0.55 | Good | 1.30 | 0 |
| 8 | 1.3 | 2 | 0.65 | Good | 0.10 | 0 |
| 9 | 1.5 | 2 | 0.75 | Defective | −0.80 | 0.15 |
| 10 | 1.7 | 2 | 0.85 | Defective | −1.10 | 2.70 |

In the case of No. 1 (Comparative Example), when a thickness of the support member 20 of the coil component is formed to be 40 μm or less, it may be difficult to distribute stress applied to the coil and the support member, resulting in substrate sagging. Specifically, in the case of Comparative Example, it may be difficult to be vulnerable to stress distribution in the first direction (X-direction) in the coil 300. In particular, because a length in the first direction (X-direction) is often larger than a length in the second direction (Y-direction) due to the structure of the coil component, in the case of Comparative Example, it may be inevitably relatively vulnerable to substrate sagging. In addition, in the case of Comparative Example, a distance between the support member and the Y-Z surface is too close, so that there may be a risk of a magnetic material falling off when manufacturing coil components, that is a risk of chipping defects.

In the case of No. 2, a gap between the connection portions is too close to effectively distribute stress in the first direction (X-direction), and there may be a risk of chipping defects.

In the case of No. 3 to No. 8, it can be seen that the substrate sagging phenomenon is improved, and Ls is improved compared to Comparative Example. This is because the connection portions 221 and 222 are disposed to avoid a region in which magnetic flux is concentrated, thereby facilitating circulation of the magnetic flux. In addition, if a gap(S) between a pair of connection portions becomes too narrow, the risk of a magnetic material falling off (chipping defect) increases.

In the case of No. 9 and No. 10, it can be seen that a distance between the connection portion and a Y-Z surface becomes too close, so that Ls is reduced, and a chipping defect rate increases again. In addition, if a gap between connection portions increases, rigidity of the substrate may decrease and substrate sagging may occur.

Therefore, referring to [Table 1], it can be seen that when S/L is maintained at 0.15 or more and 0.65 or less, it is a structure that can efficiently distribute stress, and substrate sagging of the coil component may be prevented. In addition, chipping defects may be prevented and Ls may be improved.

The length L of the body 100 in the first direction (X-direction) may be measured by analogizing the method of measuring the length of the coil component 1000 described above. Furthermore, the length S of the pair of connection portions spaced apart in the first direction (X-direction) can also be measured by analogizing the method of measuring the length of the coil component 1000 described above. In particular, the length S of the pair of connection portions spaced apart does not mean a distance between a center of a connection portion and a center of another connection portion, but may mean a physically spaced distance, that is, a distance from adjacent surfaces between the connection portions.

Thereby, the coil component 1000 according to the present embodiment may be formed so that a pair of connection portions 221 and 222 are spaced apart, thereby minimizing deformation of the support member 210 and the coil 300 that may occur during the manufacturing process.

The coil 300 is buried in the body 100 and exhibits the characteristics of a coil component. For example, when the coil component 1000 of the present embodiment is used as a power inductor, the coil 300 may play a role in stabilizing a power supply of an electronic device by storing an electric field as a magnetic field to maintain an output voltage.

The coil 300 includes coil patterns 311 and 312, lead-out portions 331 and 332, and a via 320. Specifically, based on directions of FIGS. 1, 4, and 5, a first coil pattern 311 and a first lead-out portion 331 are disposed on a lower surface of the support member 210 facing the sixth surface 106 of the body 100, and a second coil pattern 312 and a second lead-out portion 332 are disposed on an upper surface of the support member 210. The via 320 penetrates the support member 210 and contacts the first coil pattern 311 and the second coil pattern 312, respectively. Thereby, the coil 300 may function as a single coil forming one or more turns around a core 110 as a whole.

Each of the first coil pattern 311 and the second coil pattern 312 may have a planar spiral shape with at least one turn centered on the core 110. For example, the first coil pattern 311 may form at least one turn about the core 110 on the lower surface of the support member 210.

The first and second lead-out portions 331 and 332 may extend to the first and second surfaces 101 and 102 of the body, respectively, and may be connected to first and second external electrodes 400 and 500, to be described later.

The first and second lead-out portions 331 and 332 may have a structure in which a plurality of strips are combined. Referring to FIG. 2, the second lead-out portion 332 may include a plurality of strip-shaped conductors 3321 and 3322. When the second lead-out portion 332 has a plurality of strip-shaped conductors 3321 and 3322, an overplating phenomenon that may occur in a process of forming the second lead-out portion 332 can be alleviated. As a result, As a result, a deviation in a plating thickness the second coil pattern 312 and the second lead-out portion 332 can be reduced.

The plurality of strip-shaped conductors 3321 and 3322 may be formed to be spaced apart in the second direction (Y-direction), and the body 100 can be filled in spaces therebetween. As a result, coupling force and inductance characteristics of the body 100 and the second coil pattern 312 may be improved.

At least one of the coil patterns 311 and 312, the first and second lead-out portions 331 and 332, or the via 320 may include one or more conductive layers. As an example, when the second coil pattern, the second lead-out portion 332, and the via 320 are formed on the other surface of the support member 210, by plating, the second coil pattern 312, the second lead-out portion 332, and the via 320 may include a seed layer such as an electrodeless plating layer, or the like, and an electroplating layer, respectively. Here, the electroplating layer may have a single-layer structure or a multilayer structure. The electroplating layer having a multilayer structure may be formed as a conformal film structure in which one electroplating layer is covered by another electroplating layer, and may also be formed into a shape in which another electroplating layer is stacked only on one surface of one electroplating layer. The seed layer of the second coil pattern 312, the seed layer of the second lead-out portion 332, and the seed layer of the via 320 may be integrally formed, so that no boundary may be formed therebetween, but the present disclosure is not limited thereto. The electroplating layer of the second coil pattern 312, the electroplating layer of the second lead-out portion 332, and the electroplating layer of the via 320 may be integrally formed, so that no boundary is formed therebetween, but the present disclosure is not limited thereto.

As another example, based on directions of FIGS. 1, 4, and 5, when the first coil pattern 311 and the first lead-out portion 331 disposed on a lower surface of the support member 210, and the second coil pattern 312 and the second lead-out portion 332 disposed on the upper surface are formed separately from each other, and then laminated on the support member 210 in batch to form a coil 300, the via 320 may include a high-melting point metal layer and a low-melting point layer having a melting point lower than a melting point of the high-melting point metal layer. Here, the low-melting point metal layer may be formed of solder containing lead (Pb) and/or tin (Sn). At least a portion of the low-melting point metal layer may be melted due to the pressure and temperature during batch lamination, so that, for example, an intermetallic compound layer (IMC Layer) may be formed at a boundary between the low-melting point metal layer and the second coil pattern 312.

Based on a third direction (Z direction) of FIGS. 4 and 5, the coil patterns 311 and 312 and the lead-out portions 331 and 332 may be formed to protrude from the lower and upper surfaces of the support member 210, respectively. As another example, the first coil pattern 311 and the first lead-out portion 331 may be formed to protrude from the lower surface of the support member 210, and the second coil pattern 312 and the second lead-out portion 332 may be embedded in the upper surface of the support member 210 so that the upper surface of each of the second coil pattern 312 and the second lead-out portion 332 may be exposed to the upper surface of the support member 210. In this case, a concave portion may be formed on an upper surface of the second coil pattern 312 and/or the second lead-out portion 332, and the upper surface of the second coil pattern 312 and/or the second lead-out portion 332 and the upper surface of the support member 210 may not be located on the same plane. As another example, the second coil pattern 312 and the second lead-out portion 332 may be formed to protrude from the upper surface of the support member 210, and the first coil pattern 311 and the first lead-out portion 331 may be embedded in the lower surface of the support member 210 so that the lower surface of each of the first coil pattern 311 and the first lead-out portion 331 may be exposed to the lower surface of the support member 210. In this case, a concave portion may be formed on a lower surface of the first coil pattern 311 and/or the first lead-out portion 331, and the lower surface of the first coil pattern 311 and/or the first lead-out portion 331 and the lower surface of the support member 210 may not be located on the same plane.

Each of the coil patterns 311 and 312, the lead-out portions 331 and 332, and the vias 320 may be formed of a conductive material such as copper (Cu), aluminum (Al), silver (Ag), tin (Sn), gold (Au), and nickel (Ni), lead (Pb), titanium (Ti), or alloys thereof, but the present disclosure is not limited thereto.

The external electrodes 400 and 500 are disposed on the surface of the body 100 and connected to each of the first and second lead-out portions 331 and 332. In this embodiment, the first and second lead-out portions 331 and 332 extend to the first and second surfaces 101 and 102 of the body 100, respectively. Accordingly, the first external electrode 400 may be disposed on the first surface 101 and connected to be in contact with the first lead-out portion 331 extending to the first surface 101 of the body 100, and the second external electrode 500 may be disposed on the second surface 102 and connected to be in contact with the second lead-out portion 332 extending to the second surface 102 of the body 100.

The external electrodes 400 and 500 may be formed of a single-layer or multilayer structure. As an example, the first external electrode 400 may be formed of a first layer containing copper, a second layer disposed on the first layer and containing nickel (Ni), and a third layer disposed on the second layer and containing tin (Sn). Here, the first to third layers may respectively be formed by plating, but the present disclosure is not limited thereto. As another example, the first external electrode 400 may include a resin electrode including conductive powder and a resin, and a plating layer formed on the resin electrode.

The external electrodes 400 and 500 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

The insulating film IF may be formed on the support member 210 and the coil 300. In addition, the insulating film IF may also be formed on the connection portions 221 and 222. The insulating film IF is used to insulate the coil 300 from the body 100, and may include a known insulating material such as parylene, but the present disclosure is not limited thereto. Any insulating material included in the insulating film IF may be used, and there is no particular limitation. The insulating film IF may be formed by a method such as vapor deposition, but the present disclosure is not limited thereto, and may be formed by laminating an insulating film on the support member 210 and both surfaces of the connection portions 221 and 222. In the former case, the insulating film IF may be formed in the form of a conformal film along surfaces of the support member 210, the connection portions 221 and 222, and the coil 300. Meanwhile, in the present disclosure, the insulating film IF is an optional component, so if the body 100 may secure sufficient insulation resistance at an operating voltage and operating current of the coil component 1000 according to the present embodiment, the insulating film IF may be omitted.

As set forth above, according to the present disclosure, it is possible to reduce the thickness (low-profile) and prevent deformation of a coil and a support member.

In addition, according to the present disclosure, it is possible to prevent deterioration in inductance characteristics by maximizing a volume of a magnetic material within a coil component.

While example embodiments have been illustrated and described above, it will be apparent to those skilled in the art that modifications and variations could be made without departing from the scope of the present disclosure as defined by the appended claims.

What is claimed is:

1. A coil component, comprising:
a body;
a coil disposed within the body;
a support member disposed within the body to support the coil;
a pair of first connection portions extending from the support member to one side surface of the body; and
a pair of second connection portions extending from the support member to another side surface, facing the one side surface of the body,
wherein, when a length of the body in a first direction is L, and a distance between the pair of first connection portions extending to the one side surface of the body in a second direction, spaced apart in the first direction is S, S/L satisfies 0.15 or more and 0.65 or less.

2. The coil component of claim 1, wherein the pair of first connection portions and the pair of second connection portions respectively extend to both side surfaces of the body facing each other in the second direction.

3. The coil component of claim 1, wherein a separation distance between the pair of first connection portions is substantially same as a separation distance between the pair of second connection portions.

4. The coil component of claim 1, wherein, when a surface passing through a center of the body in the second direction is referred to as P₁,
the pair of first connection portions and the pair of second connection portions are formed symmetrically to each other, centered on the P₁ surface.

5. The coil component of claim 1, wherein, when a surface passing through the center of the body in the first direction is referred to as P₂,
the pair of first connection portions are formed symmetrically to each other, centered on the P₂ surface, and
the pair of second connection portions are formed symmetrically to each other, centered on the P₂ surface.

6. The coil component of claim 1, wherein a thickness of the support member is 40 μm or less.

7. The coil component of claim 1, wherein the support member is spaced apart from both side surfaces of the body facing each other in the second direction.

8. The coil component of claim 1, wherein a side surface of the support member extends to both side surfaces of the body facing each other in the first direction, and
when a length of the side surface of the support member in the second direction is E, and a length of the body in the second direction is W,
E/W is ½ or less.

9. The coil component of claim 1, wherein the coil comprises first and second lead-out portions, and
the first and second lead-out portions respectively extend to both side surfaces of the body facing each other in the first direction, respectively.

10. The coil component of claim 9, wherein the first and second lead-out portions are spaced apart from both side surfaces of the body facing each other in the second direction.

11. The coil component of claim 9, wherein the first and second lead-out portions include a plurality of strip-shaped conductors.

12. The coil component of claim 11, wherein the plurality of strip-shaped conductors are spaced apart in the second direction, and
a portion of the body is filled between the plurality of strip-shaped conductors.

13. The coil component of claim 1, wherein the coil comprises
a first coil pattern in a planar spiral shape disposed on one surface of the support member,
a second coil pattern in a planar spiral shape disposed on another surface of the support member, facing the one surface of the support member, and
a via penetrating through the support member to connect the first coil pattern and the second coil pattern.

14. The coil component of claim 1, further comprising:
first and second external electrodes respectively disposed on both side surfaces of the body facing each other in the first direction and respectively connected to both ends of the coil.

15. The coil component of claim 1, wherein the body comprises a resin and magnetic powder particles.

16. The coil component of claim 1, wherein the length of the body in the first direction is greater than the length of the body in the second direction.

17. The coil component of claim 1, wherein at least a portion of the coil is in contact with at least one of the pair of first connection portions or the pair of second connection portions.

18. The coil component of claim 1, further comprising
insulating film disposed on the support member and the coil.

19. The coil component of claim 18, wherein the insulating film is disposed on the pair of first connection portions and the pair of second connection portions.
